(19) United States
(12) Patent Application Publication
(10) Pub. No.: US 2023/0411757 A1
(43) Pub. Date: Dec. 21, 2023

(54) ELECTRIC VEHICLE BATTERY PACK CASE COMPRISING CONTINUOUS FIBERS AND DISCONTINUOUS FIBERS

(71) Applicants: KWANG SUNG CORPORATION LTD., Dangjin-si (KR); LOTTE CHEMICAL CORPORATION, Seoul (KR)

(72) Inventors: Cheol Min Shin, Ulsan (KR); Ho Gen Jeong, Uiwang-si (KR); Min Hyeok Hwang, Ulwang-si (KR)

(21) Appl. No.: 18/034,556

(22) PCT Filed: Oct. 15, 2021
(86) PCT No.: PCT/KR2021/014334

§ 371 Date: Apr. 28, 2023

(30) Foreign Application Priority Data
Oct. 28, 2020 (KR) 10-2020-0141300

(51) Int. Cl. H01M 50/231; H01M 50/227; H01M 50/242; H01M 50/249

(52) U.S. Cl. CPC H01M 50/231; H01M 50/227; H01M 50/242; H01M 50/249; H01M 2220/20

(57) ABSTRACT

The present invention relates to an electric vehicle battery pack case, and the purpose of the present invention is to provide an electric vehicle battery pack case which comprises continuous fibers and discontinuous fibers, and thus is lightweight and yet has rigidity.

### TECHNICAL FIELD

The following description relates to an electric vehicle battery pack case including continuous fibers and discontinuous fibers.

### BACKGROUND ART

Electric vehicles are being actively developed as a new means of transportation that effectively uses surplus power in relation to energy saving as well as solving pollution problems such as noise and exhaust gas of vehicles.

A battery pack driving an electric vehicle is composed of respective battery cells and modules connected in series and parallel. A cell is the smallest unit of a battery and consists of a configuration of an anode, a cathode, an electrolyte, and a separator, and the characteristics of the battery cells play a central role in the overall performance of an electric vehicle.

A module consists of a number of cells connected in series and/or parallel to one another and is embedded in a mechanical structure. A battery pack is embedded in a case structure so that it includes a plurality of modules, a battery management system, a thermal management system, and a sensor and controller, thereby becoming a final battery product.

As the weight of a vehicle increases, problems of decreasing energy efficiency and decreasing fuel efficiency occur. Meanwhile, a battery, which is called a solution for energy and carbon reduction, is a part whose weight reaches about 250 kg, and it is known that a 10% reduction in vehicle weight improves fuel efficiency by 5 to 7%. Therefore, it is situated as an essential task to reduce the weight of the battery and battery pack.

In particular, a battery pack in which a plurality of battery modules is stacked should not significantly affect the weight of the vehicle while having good rigidity enough to protect the battery modules from various external factors during driving. Therefore, it is a situation that various methods are being studied to solve this problem.

### DISCLOSURE OF THE INVENTION

### Technical Goals

An aspect of the present disclosure is to provide an electric vehicle battery pack case including continuous fibers and discontinuous fibers in order to solve the above-described problems.

More specifically, it is intended to provide an electric vehicle battery pack case having an advantage capable of protecting the battery modules from external impact while being lightweight by including both continuous fibers and discontinuous fibers.

However, technical goals to be achieved are not limited to those described above, and other goals not mentioned above are clearly understood by one of ordinary skill in the art from the following description.

### Technical Solutions

An electric vehicle battery pack case according to an aspect of the present disclosure includes a case main body and a cover assembled to the case main body, wherein the case main body includes continuous fibers and discontinuous fibers.

According to an embodiment of the present disclosure, the discontinuous fibers may be located on outskirts of the electric vehicle battery pack case.

According to an embodiment of the present disclosure, it may further include a flame retardant coating.

According to an embodiment of the present disclosure, the flame retardant coating may include a flame retardant and a flame retardant resin, the flame retardant may include one or more selected from the group consisting of a halogen-based flame retardant, a phosphorus-based flame retardant, and an inorganic flame retardant, and the flame retardant resin may include one or more selected from the group consisting of acrylic resins, epoxy-based resins, styrene-based resins, and phenolic resins.

According to an embodiment of the present disclosure, the flame retardant coating may be formed to a thickness of 10 μm to 1,000 μm.

According to an embodiment of the present disclosure, a ratio of a content of the continuous fibers to a content of the discontinuous fibers may be in a range of 1:1 to 1.5.

According to an embodiment of the present disclosure, the continuous fibers, the discontinuous fibers, or both thereof may each include one or more selected from the group consisting of polypropylene, polyamide, polyether ether ketone, polycarbonate, polyphenylene sulfone, polyethylene, and polyphenylene ether.

According to an embodiment of the present disclosure, the continuous fibers, the discontinuous fibers, or both thereof may each include one or more selected from the group consisting of glass fibers, carbon fibers, aramid fibers, volcanic ash fibers, natural fibers, silica, talc, nonwoven fabric fibers, and conductive fillers.

According to an embodiment of the present disclosure, the electric vehicle battery pack case may be UL94 V-0 in evaluation according to the UL94 vertical burning test (UL94 V TEST).

According to an embodiment of the present disclosure, the electric vehicle battery pack case may be extinguished within 2 minutes when exposed to flame for 70 seconds according to GB 31467.3.

According to an embodiment of the present disclosure, it may further include a synthetic resin, and the weight of the continuous fibers:the weight of the synthetic resin may be 50 to 60:40 to 50.

According to an embodiment of the present disclosure, it may further include a coupling part formed on a side surface of the electric vehicle battery pack case.

### Effects

The electric vehicle battery pack case according to an embodiment of the present disclosure includes continuous fibers and discontinuous fibers. Particularly, a part containing the continuous fibers and a part containing the discontinuous fibers are alternately formed so that it has an advantage capable of protecting the battery modules from external impact while being lightweight.

Therefore, the electric vehicle battery pack case according to the present disclosure may be used as a battery pack case or a battery housing for an electric vehicle, may promote weight reduction of electric vehicle battery parts, and may ultimately have all of the price competitiveness, stability, and weight lightening of the electric vehicle itself.

### BRIEF DESCRIPTION OF DRAWINGS

FIG. 1 is a cross-sectional view of an electric vehicle battery pack case having a three-stage structure according to an embodiment of the present disclosure.

FIG. 2 is a cross-sectional view of an electric vehicle battery pack case having a five-stage structure according to an embodiment of the present disclosure.

### BEST MODE FOR CARRYING OUT THE INVENTION

Hereinafter, embodiments will be described in detail with reference to the accompanying drawings. However, since various changes may be made to the embodiments, the scope of rights of the patent application is not restricted or limited by these embodiments. It should be understood that all modifications, equivalents and substitutes for the embodiments are included in the scope of the rights.

The terms used in the embodiments are used for the purpose of description only, and should not be construed as an intention to limit the present disclosure. The singular expression includes the plural expression unless the context clearly dictates otherwise. In the present specification, it should be understood that a term such as “comprise”, “have”, or the like is intended to designate that a feature, a number, a step, an operation, a component, a part, or a combination thereof described in the specification exists, but it does not preclude the possibility of existence or addition of one or more other features, numbers, steps, operations, components, parts, or combinations thereof.

Unless defined otherwise, all terms used herein, including technical or scientific terms, have the same meaning as those commonly understood by one of ordinary skill in the art to which the embodiments belong. Terms such as those defined in a commonly used dictionary should be interpreted as having a meaning consistent with the meaning in the context of the related art, and should not be interpreted in an ideal or excessively formal meaning unless explicitly defined in the present application.

Further, in the description with reference to the accompanying drawings, the same constituent elements are assigned the same reference numerals regardless of the reference numerals, and the overlapping description thereof will be omitted. In the description of the embodiments, if it is determined that a detailed description of a related known technology may unnecessarily obscure the gist of the embodiments, the detailed description will be omitted.

Further, in describing constituent elements of the embodiments, terms such as first, second, A, B, (a), (b), etc. may be used. These terms are only for distinguishing the constituent elements from other constituent elements, and essences, orders, sequences, or the like of the corresponding constituent elements are not limited by the terms. When it is described that a constituent element is “linked”, “coupled” or “connected” to other constituent element, the constituent element may be directly linked or connected to the other constituent element, but it should be understood that another constituent element may also be “linked”. “coupled” or “connected” between the respective constituent elements.

Constituent elements included in any an embodiment and constituent elements including a common function will be described using the same names in other embodiments. Unless otherwise stated, descriptions described in any an embodiment may also be applied to other embodiments, and detailed descriptions will be omitted within the overlapping range.

An electric vehicle battery pack case according to an aspect of the present disclosure includes a case main body and a cover assembled to the case main body, and the case main body includes continuous fibers and discontinuous fibers.

Continuous fibers generally refer to fibers having a large aspect ratio and a specific orientation. The continuous fibers include continuous fibers, and the continuous fibers may be arranged in one direction or formed to be crossed at 90° or 30°.

On the other hand, discontinuous fibers are a commonly used term to distinguish them from the continuous fibers, and unlike the continuous fibers, the discontinuous fibers may mean that fibers having a relatively short length are randomly arranged.

The continuous fibers have high strength and rigidity and are hard, whereas the discontinuous fibers have disadvantages in that they are relatively inexpensive and easy to process.

An electric vehicle battery pack case according to an embodiment of the present disclosure may provide a case excellent in all of processability, rigidity, and dimensional stability by forming a continuous fiber-containing part and a discontinuous fiber-containing part alternately.

In addition, it includes two or more discontinuous fiber-containing parts so that there is an advantage in that processability can be improved compared to a plastic case made of only the continuous fiber-containing part.

According to an embodiment of the present disclosure, the discontinuous fibers may be located on the outskirts of the electric vehicle battery pack case.

The discontinuous fibers may be formed to surround the continuous fibers.

One or more of the discontinuous fiber-containing parts may be further included than the continuous fiber-containing part, and desirably, one of the discontinuous fiber-containing part may be further included than the continuous fiber-containing part.

The electric vehicle battery pack case according to an embodiment of the present disclosure may include a discontinuous fiber-containing part on the outskirts, based on its cross section, and the continuous fiber-containing part and the discontinuous fiber-containing part may be formed to be crossed.

According to an embodiment, based on its cross section, the electric vehicle battery pack case may be formed in an A-B-A structure in which the discontinuous fiber-containing part, the continuous fiber-containing part, and the discontinuous fiber-containing part are alternately arranged in the order, and it may be formed in an A-B-A-B-A structure in which the discontinuous fiber-containing part, the continuous fiber-containing part, the discontinuous fiber-containing part, and the continuous fiber-containing part are alternately arranged in the order.

Alternate formation of the continuous fiber-containing part and the discontinuous fiber-containing part may be disposing the discontinuous fiber-containing part on the outskirts, but is not limited to the examples described above.

Discontinuous fibers have relatively high processability compared to continuous fibers so that the electric vehicle battery pack case according to an embodiment of the present disclosure is, for example, used as a battery pack or battery housing used in an electric vehicle, thereby having an advantage capable of easily inserting assembly screws, etc.

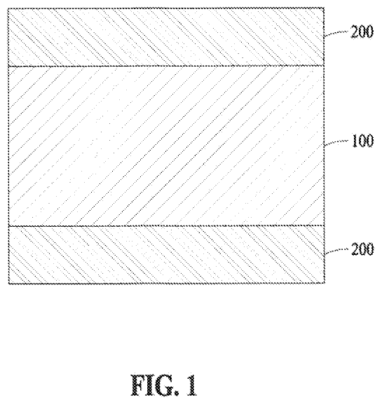

FIG. 1 is a cross-sectional view of an electric vehicle battery pack case having a three-stage structure according to an embodiment of the present disclosure.

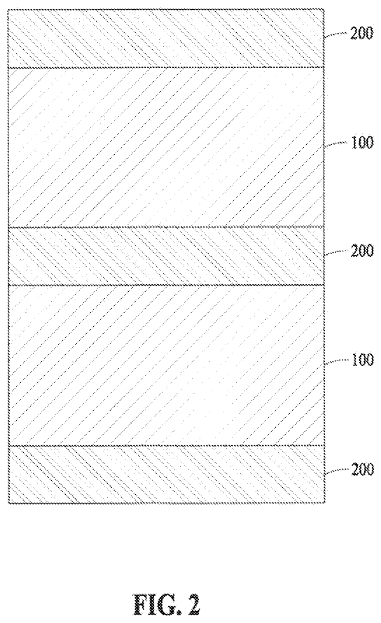

FIG. 2 is a cross-sectional view of an electric vehicle battery pack case having a five-stage structure according to an embodiment of the present disclosure.

Referring to FIGS. 1 and 2, the electric vehicle battery pack case is formed so that the discontinuous fiber-containing part 200 is located on the outskirts, and the discontinuous fiber-containing part 200 and the continuous fiber-containing part 100 may be located so that they are formed to be crossed.

It is sufficient that the discontinuous fiber-containing part 200 is formed by crossing the continuous fiber-containing part 100, and as shown in FIG. 1 or 2, the continuous fiber-containing part and discontinuous fiber-containing part need not be formed to be crossed in the form of a three-stage structure or a five-stage structure.

According to an embodiment of the present disclosure, it may further include a flame retardant coating.

The flame retardant coating is desirably formed on the outer surface of the battery pack case, but in addition to this, it may be additionally formed on the inside or between the inner layers.

In particular, a battery pack or battery housing used in an electric vehicle is a part in which a battery is stacked, and requires flame retardancy in preparation for heating of the battery during driving or explosion or the like of the battery due to external impact.

The electric vehicle battery pack case according to an embodiment of the present disclosure has the advantage of capable of ensuring safety by further including a flame retardant coating.

According to an embodiment of the present disclosure, the flame retardant coating includes a flame retardant and a flame retardant resin, the flame retardant includes one or more selected from the group consisting of a halogen-based flame retardant, a phosphorus-based flame retardant, and an inorganic flame retardant, and the flame retardant resin may include one or more selected from the group consisting of acrylic resins, epoxy-based resins, styrene-based resins, and phenolic resins.

The halogen-based flame retardant may include a brominated flame retardant, a chlorine-based flame retardant, or both thereof, the brominated flame retardant may include decabromophenoxyethane (DBDPE), tetrabromobisphenol A (TBBPA), or both thereof, and the chlorine-based flame retardant may include one or more selected from the group consisting of chlorinated paraffin, chlorinated polyethylene, and aliphatic chlorine-based flame retardants.

The phosphorus-based flame retardant may contain one or more functional groups selected from the group consisting of phosphate, phosphonate, phosphinate, phosphine oxide, and phosphazene, and may include phosphorus/halogen flame retardants, phosphorus/nitrogen flame retardants, and the like.

The inorganic flame retardant may include one or more selected from the group consisting of aluminum hydroxide (Al(OH)₃), antimony oxide (Sb₂O₃), and magnesium hydroxide (Mg(OH)₂).

The type of the flame retardant resin used in the present disclosure is not particularly limited. As an example, an aromatic vinyl-based polymer resin, a polyphenylene ether resin, a polyphenylene sulfide resin, a polyalkyl (meth)acrylate resin, a polycarbonate resin, a polyolefin-based resin, a polyester-based resin, a polyamide-based resin, etc. may be used.

In addition, as an example, an epoxy-based resin, a styrene-based resin, a phenolic resin, and the like may be used as the flame retardant resin.

According to an embodiment of the present disclosure, the flame retardant coating may be formed to a thickness of 10 μm to 1,000 μm.

If the thickness of the flame retardant coating is smaller than the above numerical range, a sufficient flame retardant effect may not be exhibited, and if it is larger than the above numerical range, the flame retardant effect is excellent, but there is a disadvantage in that a significant cost is incurred.

According to an embodiment of the present disclosure, it may further include an additive, wherein the additive may include one or more selected from the group consisting of a heat stabilizer, a UV stabilizer, an antioxidant, a lubricant, a plasticizer, a filler, a reinforcement, an extender, a colorant, an anti-drip agent, a nucleating agent, an antiblocking agent, a slip agent, an antibacterial agent, an antifungal agent, an antistatic agent, a curing agent, a foaming agent, and a compatibilizer.

Each of the above-mentioned additives is not particularly limited, but for example, the heat stabilizer may include Cd/Ba/Zn-based, Cd/Ba-based, Ba/Zn-based, Ca/Zn-based, Na/Zn-based, Sn-based, Pb-based, Cd-based, and Zn-based heat stabilizers, and the UV stabilizer may include a benzophenone-based UV stabilizer, a benzotriazole-based UV stabilizer, organic nickel compounds, and the like.

The antioxidant may include phenols, aromatics, amines, thioesters, phosphites, and the like, and the lubricant may include an aliphatic higher fatty alcohol-based lubricant, a dicarboxylic ester-based lubricant, a fatty acid esters of glycerol-based lubricant, a short-chain alcohol-based lubricant, a fatty acid-based lubricant, a fatty acid amide-based lubricant, and a metallic soap-based lubricant, metal lubricants (as an example, Ca stearate), and the like.

As an example, in order to satisfy the mechanical properties, processing properties, surface properties, thermal properties, chemical properties, and aesthetic properties of the electric vehicle battery pack case, the additive may be contained at a ratio of 0.1 parts by weight to 10 parts by weight with respect to the part by weight of the electric vehicle battery pack case. The additive may be desirably contained at a ratio of 0.1 parts by weight to 2 parts by weight.

According to an embodiment of the present disclosure, a ratio of a content of the continuous fibers to a content of the discontinuous fibers may be in a range of 1:1 to 1.5.

The continuous fibers may have a thickness greater than that of the discontinuous fibers, and desirably, the ratio of the content of the continuous fibers to the content of the discontinuous fibers may be in the range of 1:1.1 to 1.5.

According to an embodiment of the present disclosure, the continuous fibers, the discontinuous fibers, or both thereof may each include one or more selected from the group consisting of polypropylene, polyamide, polyether ether ketone, polycarbonate, polyphenylene sulfone, polyethylene, and polyphenylene ether.

Continuous fibers, discontinuous fibers, or both thereof may each include a matrix resin, and may be appropriately selected depending on the use and purpose of the electric vehicle battery pack case.

According to an embodiment of the present disclosure, the continuous fibers, the discontinuous fibers, or both thereof may each include one or more selected from the group consisting of glass fibers, carbon fibers, aramid fibers, volcanic ash fibers, natural fibers, silica, talc, nonwoven fabric fibers, and conductive fillers.

The criteria for the continuous fibers and the discontinuous fibers are based on the length of the fibers, and according to an embodiment of the present disclosure, the compositions of the continuous fibers and the discontinuous fibers may be the same or different.

In particular, in the case of continuous fibers including long fibers, the physical properties of plastics can be greatly strengthened, and thus there is an advantage capable of manufacturing plastic products such as electric vehicle battery pack cases that are lightweight and maintain high strength.

According to an embodiment of the present disclosure, the electric vehicle battery pack case may be UL94 V-0 in evaluation according to the UL94 vertical burning test (UL94 V TEST).

The UL94 test is a plastic flame retardancy test by Underwriters Laboratories and corresponds to the international flammability safety standard for plastic materials in parts.

According to the UL94 V test, the specimen should be placed vertically and set on fire with a burner so that the fire on the specimen should be extinguished by itself within a certain period of time, and the standard of the specimen with 5 inches (127 mm) in length, 0.5 inch (12.7 mm) in width, and ½, ¼, ⅛, 1/16, and 1/32 inch in thickness may be used.

It may be tested after leaving it alone for at least 48 hours under a temperature of 23±2° C. and a relative humidity of 50±5 RH, and after applying a flame for 10 seconds by the burner, the time when the fire is extinguished may be measured.

According to an embodiment of the present disclosure, the electric vehicle battery pack case according to the present disclosure has a considerable level of flame retardancy, thereby having an advantage in that it can ensure the safety of users.

According to an embodiment of the present disclosure, the electric vehicle battery pack case may be extinguished within 2 minutes when exposed to flame for 70 seconds according to GB/T 31467.3.

GB/T 31467.3 is about the safety inspection of electric vehicle battery packs and systems in China, and indicates the standard for the Chinese flame retardant test method.

According to this, the interval between the water level of a heat source (gasoline) and the specimens is set to be 50 cm, and after directly exposed to the flame for 70 seconds, the heat source is removed, and then whether there is combustion or not may be observed for 2 hours.

In order to coincide with this standard condition, the transferred fire must be extinguished within 2 minutes, and the electric vehicle battery pack case according to an embodiment of the present disclosure may coincide with this condition.

According to an embodiment of the present disclosure, it may further include a synthetic resin, and the weight of the continuous fibers:the weight of the synthetic resin may be 50 to 60:40 to 50.

According to an embodiment, the synthetic resin may include one or more selected from the group consisting of polypropylene, polyamide, polyether ether ketone, polycarbonate, polyphenylene sulfone, polyethylene, and polyphenylene ether.

According to an embodiment, the continuous fibers may include one or more selected from the group consisting of glass fibers, carbon fibers, aramid fibers, volcanic ash fibers, natural fibers, silica, talc, nonwoven fabric fibers, and conductive fillers.

According to an embodiment of the present disclosure, it may further include a coupling part formed on a side surface of the electric vehicle battery pack case.

The coupling part may be formed on the side surface of the electric vehicle battery pack case to couple the top and bottom surfaces of the electric vehicle battery pack case.

As described above, the discontinuous fibers may have good processability, and thus the coupling part may have good fastening properties.

Although the embodiments have been described as above, one of ordinary skill in the art may apply various technical modifications and variations based on the above description. For example, although the described techniques are performed in an order different from the described method, and/or the constituent elements such as the described system, structure, apparatus, circuit, etc. are coupled or combined in a form different from the described method, or replaced or substituted by other constituent elements or equivalents, appropriate results may be accomplished.

Therefore, other implementations, other embodiments, and equivalents to the claim scope also belong to the scope of the following claims.

1. An electric vehicle battery pack case comprising a case main body and a cover assembled to the case main body,
wherein the case main body comprises continuous fibers and discontinuous fibers.

2. The electric vehicle battery pack case of claim 1, wherein the discontinuous fibers are located on outskirts of the electric vehicle battery pack case.

3. The electric vehicle battery pack case of claim 1, further comprising a flame retardant coating.

4. The electric vehicle battery pack case of claim 3, wherein
the flame retardant coating comprises a flame retardant and a flame retardant resin,
is the flame retardant comprises one or more selected from the group consisting of a halogen-based flame retardant, a phosphorus-based flame retardant, and an inorganic flame retardant, and
the flame retardant resin comprises one or more selected from the group consisting of acrylic resins, epoxy-based resins, styrene-based resins, and phenolic resins.

5. The electric vehicle battery pack case of claim 3, wherein the flame retardant coating is formed to a thickness of 10 μm to 1,000 μm.

6. The electric vehicle battery pack case of claim 1, wherein a ratio of a content of the continuous fibers to a content of the discontinuous fibers is in a range of 1:1 to 1.5.

7. The electric vehicle battery pack case of claim 1, wherein the continuous fibers, the discontinuous fibers, or both thereof each comprise one or more selected from the group consisting of polypropylene, polyamide, polyether ether ketone, polycarbonate, polyphenylene sulfone, polyethylene, and polyphenylene ether.

8. The electric vehicle battery pack case of claim 1, wherein the continuous fibers, the discontinuous fibers, or both thereof each comprise one or more selected from the group consisting of glass fibers, carbon fibers, aramid fibers, volcanic ash fibers, natural fibers, silica, tale, nonwoven fabric fibers, and conductive fillers.

9. The electric vehicle battery pack case of claim 1, wherein the electric vehicle battery pack case is UL94 V-0 in evaluation according to the UL94 vertical burning test (UL94 V TEST).

10. The electric vehicle battery pack case of claim 1, wherein the electric vehicle battery pack case is extinguished within 2 minutes when exposed to flame for 70 seconds according to GB/T 31467.3.

11. The electric vehicle battery pack case of claim 1, further comprising a synthetic resin,
wherein the weight of the continuous fibers:the weight of the synthetic resin is 50 to 60:40 to 50.

12. The electric vehicle battery pack case of claim 1, further comprising a coupling part formed on a side surface of the electric vehicle battery pack case.
